(19) United States
(12) Patent Application Publication
(10) Pub. No.: US 2025/0049246 A1
(43) Pub. Date: Feb. 13, 2025

(54) SOUS VIDE FOOD AND CONDIMENT DISPENSERS

(71) Applicant: Robert Almblad, Lynchburg, VA (US)

(72) Inventor: Robert Almblad, Lynchburg, VA (US)

(21) Appl. No.: 18/779,762

(22) Filed: Jul. 22, 2024

Related U.S. Application Data
(60) Provisional application No. 63/528,358, filed on Jul. 22, 2023.
(60) Provisional application No. 63/534,959, filed on Aug. 28, 2023.
(60) Provisional application No. 63/536,394, filed on Sep. 2, 2023.
(60) Provisional application No. 63/539,204, filed on Sep. 19, 2023.
(60) Provisional application No. 63/542,634, filed on Oct. 5, 2023.
(60) Provisional application No. 63/649,339, filed on May 18, 2024.

(51) Int. Cl. A47J 27/10

(52) U.S. Cl. CPC A47J 27/10

(57) ABSTRACT

A sous vide food dispensing system for rethermalizing and dispensing a sous vide food portion from a sous vide food pouch includes a housing, a heating chamber configured to heat the sous vide food portion to a serving temperature, a movable post configured to move the sous vide food pouch with the sous vide food portion therein into the heating chamber; and a cutting device configured to cut the sous vide food pouch to facilitate dispensing of the sous vide food portion.

### PRIORITY INFORMATION

The present application claims priority, under 35 U.S.C. § 119(e), from U.S. Provisional Patent Application No. 63/528,358, filed on Jul. 22, 2023. The entire content of U.S. Provisional Patent Application No. 63/528,358, filed on Jul. 22, 2023, is hereby incorporated by reference.

The present application claims priority, under 35 U.S.C. § 119(e), from U.S. Provisional Patent Application No. 63/534,959, filed on Aug. 8, 2023. The entire content of U.S. Provisional Patent Application No. 63/534,959, filed on Aug. 8, 2023, is hereby incorporated by reference.

The present application claims priority, under 35 U.S.C. § 119(e), from U.S. Provisional Patent Application No. 63/536,394, filed on Sep. 2, 2023. The entire content of U.S. Provisional Patent Application No. 63/536,394, filed on Sep. 2, 2023, is hereby incorporated by reference.

The present application claims priority, under 35 U.S.C. § 119(e), from U.S. Provisional Patent Application No. 63/539,204, filed on Sep. 19, 2023. The entire content of U.S. Provisional Patent Application No. 63/539,204, filed on Sep. 19, 2023, is hereby incorporated by reference.

The present application claims priority, under 35 U.S.C. § 119(e), from U.S. Provisional Patent Application No. 63/542,634, filed on Oct. 5, 2023. The entire content of U.S. Provisional Patent Application No. 63/542,634, filed on Oct. 5, 2023, is hereby incorporated by reference.

The present application claims priority, under 35 U.S.C. § 119(e), from U.S. Provisional Patent Application No. 63/649,339, filed on May 18, 2024. The entire content of U.S. Provisional Patent Application No. 63/649,339, filed on May 18, 2024, is hereby incorporated by reference.

### BACKGROUND

Various types of cooking devices are known in the art. Specifically, various types of grills are known. In one type of grill, the food is placed on a grilling surface, grilling the side of the food that contacts the grilling surface. After that side of the food is cooked, the food is manually turned or flipped to cook the opposite side. After the second side of the food is cooked, the food is removed from the grill for further preparation and/or serving.

In another type of grill, two-sided cooking is accomplished simultaneously. Such grills are commonly known as clamshell grills and have upper and lower cooking platens that are horizontally opposed for contacting the two sides of a food item simultaneously to thereby cook both sides simultaneously.

For proper performance, the two grilling surfaces should be parallel to each other so that each surface uniformly contacts and cooks the associated side of the food item that contacts a respective platen cooking surface.

There is a large amount of activity in the general field of restaurant automation in context of hygienic handling of various food product(s), and several studies and research as well as invention(s) have delved upon the subject(s) of ‘packaging’ and ‘unpackaging’ procedures/methods. Protocols such as lamination, sheet-layering, foil packaging and peeling off, dismantling and delamination, at the manufacture sites (food processing factories/units) and usage sites (restaurants, hotels and eating points) are known to be in existence in the prior art profile.

The prior art discloses patents on delamination of a laminate, use of conveyor belts to transport laminated food products from one place to other, as well as use of several methods for unpacking the laminated food products such as peeling of film, delamination of laminated food and also in some cases the deployment of stripper unit. However, the prior art profile does not eliminate the need for human interference such as the food product directly passed on to a cooking unit.

U.S. Pat. No. 5,141,584 discloses an apparatus and method for delaminating a composite sheet structure of the kind comprising a vertically frangible layer having a first surface adhesively bonded to a first sheet at a substantially uniform strength and an opposite surface abutting areas which are, respectively, adhesively bonded to a second sheet at strengths less or greater than the uniform strength and having a marginal portion or tab extending beyond the first sheet. The entire content of U.S. Pat. No. 5,141,584 is hereby incorporated by reference.

U.S. Pat. No. 6,244,019 discloses a system for packaging and unpackaging can lids. The entire content of U.S. Pat. No. 6,244,019 is hereby incorporated by reference.

U.S. Pat. No. 8,367,977 discloses a compact portable heating device adapted to heat multiple food products simultaneously is provided. The entire content of U.S. Pat. No. 8,367,977 is hereby incorporated by reference.

U.S. Pat. No. 8,822,886 discloses a compact portable heating device adapted to heat multiple food products simultaneously is provided. The entire content of U.S. Pat. No. 8,822,886 is hereby incorporated by reference.

U.S. Pat. No. 9,861,229 discloses a movable door that directs debris, such as oil, grease, and food particles, that falls from a plurality of cooking slots in a vertical cooking grill to an area separate from a food product delivery tray, providing a cooked food product with reduced calories that is potentially more visually appealing. The entire content of U.S. Pat. No. 9,861,229 is hereby incorporated by reference.

U.S. Pat. No. 9,867,501 discloses a food loading system provides the ability to stage a volume of food in a freezer or cooler that keeps food product safely stored until the product is ready to be transferred to a cooking unit. The entire content of U.S. Pat. No. 9,867,501 is hereby incorporated by reference.

In addition, the closing device closes the open package end by compressing the bag end in the unfolding condition and in that fastening means are applied retaining the closed condition, and the unpacking device causes relative movement of the packages and the can lids contained therein in such a manner that the can lids are pressed against the package end closed by means of the fastening means.

Sous vide or cooking under a vacuum is well known, particularly in fine restaurants for the past several decades. It is the process of cooking food vacuum sealed in plastic for a long time at low temperatures. After the food is cooked, the plastic is removed, and the food is “finished” with extreme heat to give it that crispy outer surface and taste and “mouth feel” that humans have grown to expect from well prepared foods. While sous vide is universally accepted and recognized as the best way known to cook food, it has some serious drawbacks. First and foremost, it takes a long time to cook food. Even for a single serving, it takes at least 1 to 2 hours depending on the thickness of the food. If a customer in a restaurant orders food, the customer does not want to wait that long to get served.

Another drawback is that each type of food being cooked needs to be cooked at an exact temperature for that particular food. For example, medium rare and medium steaks are cooked at 135° F. and 140° F. respectively. Asparagus and carrots are cooked at different temperatures and for different lengths of time as well.

The combinations to make everyone happy in a typical restaurant are endless and would require customers to sit for hours while hundreds of different ovens and different chefs slowly cooked their food.

Since the sous vide method is the safest and best-tasting food, there have been many attempts to alleviate these inherent problems.

In fine dining, chefs prepare the food sous vide style in multiple ovens days or weeks ahead of time and refrigerate the food and then rethermalate when the customer orders the food. This is a reasonable solution, but the labor costs, associated therewith, are so high.

To address this problem of sous vide only being available in fine dining and very expensive restaurants, a practical solution has been to cook sous vide style food at a central plant, where time is not an issue because the wholesale customer is the restaurant itself that is getting refrigerated 40° F. deliveries once a week rather than a restaurant's retail customer that is waiting in the dining room for their hot lunch in the next 15 minutes.

This wholesale method has worked fairly well so that more and more restaurants can now buy previously sous vide food from a large, national sous vide “plant” and then rethermalize and finish the previous sous vide'd food within 15 minutes after the retail restaurant customer orders the food from the dining room of the restaurant.

While this solution works fairly well for restaurants that have customers waiting in a sit-down dining room for 15 minutes and are willing to pay a premium price for a sit-down restaurant. It does not work for fast-food locations because not only is 15 minutes too long for the customer to wait, but also; fast food restaurants' success depends on the low price of their food which is mostly determined by the amount of labor used to deliver the food.

Generally speaking, fast-food restaurants need to prepare food in 30 seconds or less in order to meet the demands of their busy customers and to do this without adding additional personnel so they can have the profit margins needed to maintain an “ongoing business” in the meaning of the accounting term. If the time needed to prepare food is more than 30 seconds, it is either not sold by the fast-food restaurant or it is delivered on a “cook and hold” basis. The hold times are different for different products.

If the food is not used within the limited allotted time, it should be thrown away. If this food waste goes too high, the fast-food restaurant will not meet the definition of an ongoing business and therefore will fail. Consequently, fast-food restaurants try to limit these losses by cooking faster and/or holding longer, both of which tend to degrade the food.

The overall problem that all restaurants face today is the availability, training, and cost of labor. Regardless of what food is served, labor is very expensive because of the training needed to work with food. Mistakes can not only make the business fail because the food tastes bad or the service is bad, but also, if there is mishandling of food, it can cause the sickness or death of restaurant customers.

The obvious solution has been to automate the restaurant. While there have been many attempts to automate cooking with robots, none have been very successful. The main problem with automation has been the size and sanitation of equipment intended to work inside a modern restaurant kitchen.

The features of the afore-mentioned prior art disclose complex design and bulky structural indices thereby hindering utilization in restaurant automation devices.

Moreover, the afore-mentioned prior art fails to address the use of restaurant automation in highly aseptic conditions by eliminating human interference during transfer of food products from refrigerated storage to cooking unit.

Therefore, it is desirable to provide a system that enables the automation of a sous vide food product cooking apparatus which minimizes human interaction and provides an efficient and consistent cooking process.

FIG. 1 illustrates a prior art condiment dispenser system. As illustrated in FIG. 1, a condiment dispenser system 10 includes a condiment dispenser cabinet or compartment 11, which as illustrated, includes multiple condiment dispensing containers 13 filled with condiments 14. The condiment dispenser cabinet or compartment 11 includes a door 12 to access the inside of the condiment dispenser cabinet or compartment 11 so that a person can replace an empty condiment dispensing container 13. Condiments 14 are dispensed by a non-disposable human operated valve system 15, relying upon gravity to feed the non-disposable human operated valve system 15.

FIG. 2 illustrates another prior art condiment dispenser system. As illustrated in FIG. 2, a condiment dispenser system 20 includes a condiment dispenser cabinet or compartment 21, which as illustrated, includes a condiment dispensing container 23 filled with a condiment 24. The condiment dispenser cabinet or compartment 21 includes a lid 22 to access the inside of the condiment dispenser cabinet or compartment 21 so that a person can replace an empty condiment dispensing container 23. The condiment 14 is dispensed by a non-disposable human operated pump system 25.

As disclosed above, the prior art condiment dispenser systems include non-disposable human operated pump systems that require extensive cleaning thereof after each condiment dispensing container is replaced.

Moreover, the non-disposable human operated pump systems of the prior art condiment dispenser systems fail to substantially empty the condiment dispensing container before replacement, thereby resulting in condiment waste.

Lastly, the prior art condiment dispenser systems take up a lot of shelf place and are stackable or modular to reduce the footprint of the condiment dispenser system on the shelf.

Therefore, it is desirable to provide a condiment dispenser system that does not require extensive cleaning thereof after each condiment dispensing container is replaced.

It is also desirable to provide a condiment dispenser system that substantially empties the condiment dispensing container before replacement, thereby substantially reducing condiment waste.

It is desirable to provide a condiment dispenser system that substantially empties the condiment dispensing container before replacement, thereby substantially reducing condiment waste, and does not require extensive cleaning thereof after each condiment dispensing container is replaced.

It is desirable to provide a condiment dispenser system that is modular or stackable.

It is desirable to provide a condiment dispenser system that is modular or stackable and does not require extensive cleaning thereof after each condiment dispensing container is replaced.

It is desirable to provide a condiment dispenser system that is modular or stackable and that substantially empties the condiment dispensing container before replacement, thereby substantially reducing condiment waste.

It is desirable to provide a condiment dispenser system that is modular or stackable, does not require extensive cleaning thereof after each condiment dispensing container is replaced, and that substantially empties the condiment dispensing container before replacement, thereby substantially reducing condiment waste.

It is desirable to provide an inline heat exchanger for dispensing condiments.

It is desirable to provide an inline heat exchanger for dispensing rethermalized sous vide food.

It is desirable to provide a sous vide food package configured to control a flow rate of the sous vide food leaving the packaging based on a location of a cut in the packaging.

It is desirable to provide a sous vide rethermalization system capable of providing independent rethermalization of distinct sous vide food packages.

It is desirable to provide a sous vide rethermalization system capable of providing independent rethermalization of distinct sous vide food packages and automatically plating the distinct rethermalized sous vide food.

It is desirable to provide a sous vide rethermalization system capable of automatically providing rethermalization based on identification of the sous vide food package.

### BRIEF DESCRIPTION OF THE DRAWING

The drawings are only for purposes of illustrating various embodiments and are not to be construed as limiting, wherein:

FIG. 1 illustrates a prior art condiment dispenser;

FIG. 2 illustrates another prior art condiment dispenser;

FIG. 3 illustrates an exploded view of a condiment dispenser system;

FIG. 4 illustrates another exploded view of the condiment dispenser system of FIG. 3;

FIG. 5 illustrates a cut-away of a condiment dispenser cabinet or compartment with a full condiment dispensing container;

FIG. 6 illustrates a heat transfer unit for heating condiments for use with a condiment dispenser;

FIG. 7 illustrates a rethermalization unit for a sous vide food product dispenser;

FIG. 8 illustrates the lamination of sous vide food products;

FIG. 9 illustrates the folding of laminated sous vide food products;

FIG. 10 illustrates air gaps between folds of laminated sous vide food products;

FIG. 11 illustrates a sous vide food product dispenser;

FIG. 12 illustrates a slacking unit for a sous vide food product dispenser;

FIG. 13 illustrates a rethermalization unit for a sous vide food product dispenser;

FIG. 14 illustrates a replaceable sous vide food product storage/dispensing container;

FIG. 15 illustrates a top view of a heat exchanger of a replaceable sous vide food product storage/dispensing container;

FIG. 16 illustrates a sous vide food product dispensing unit;

FIG. 17 illustrates an embodiment of lamination of a sous vide food product;

FIG. 18 illustrates a flow control packaging for a sous vide food product;

FIG. 19 illustrates a rethermalizing/dispensing unit for sous vide food products;

FIG. 20 illustrates a flow rate control configured packaging for a sous vide food product;

FIG. 21 illustrates a rethermalization unit for distinct sous vide food products; and

FIG. 22 illustrates an automated rethermalizing/dispensing system for distinct sous vide food products.

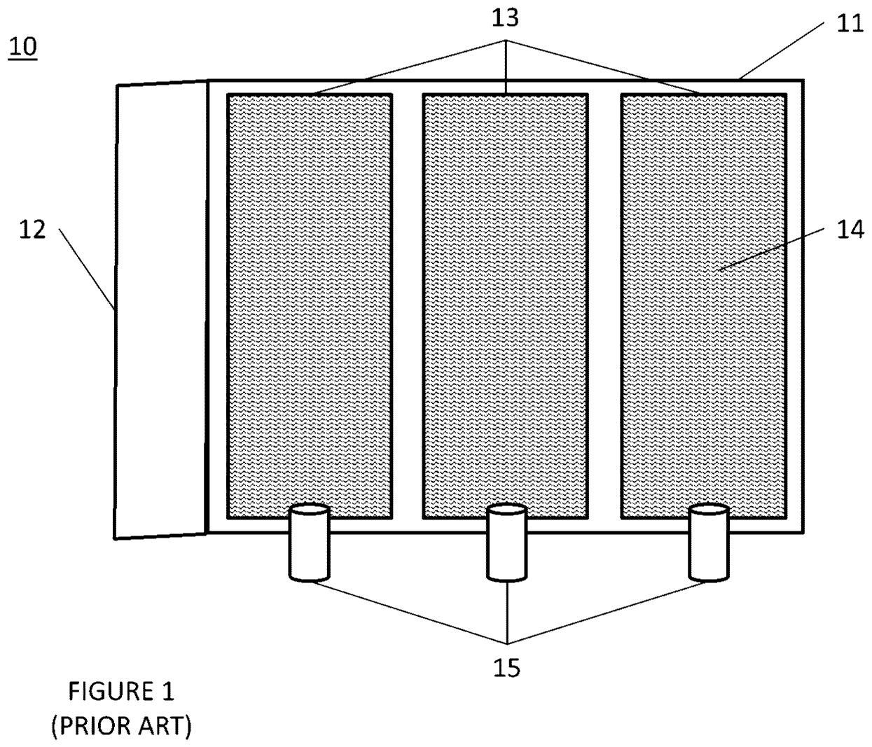

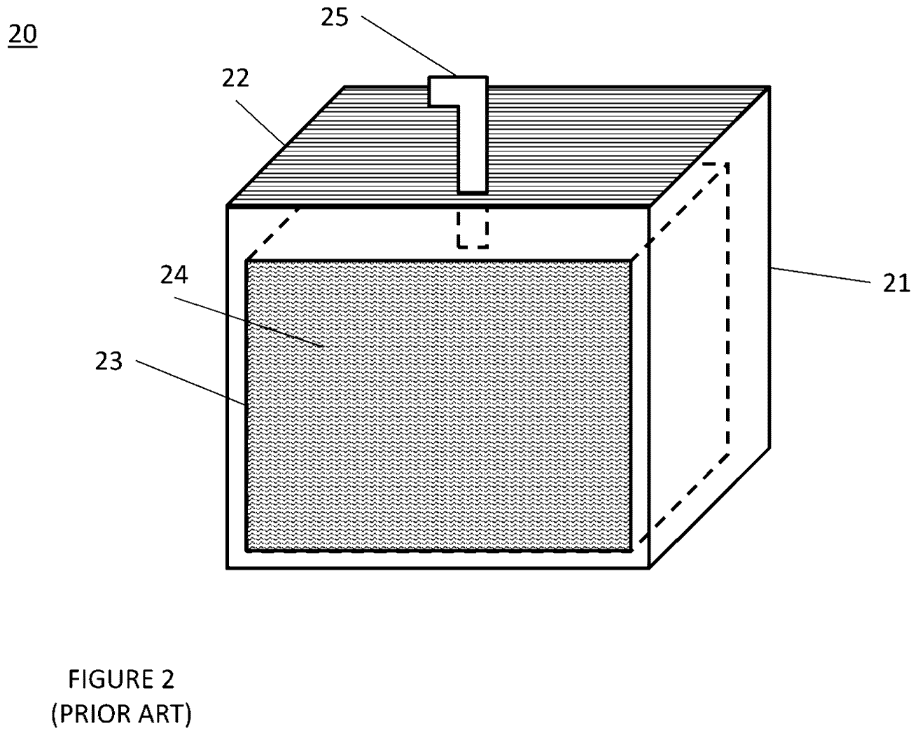

### DETAILED DESCRIPTION OF THE DRAWINGS

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

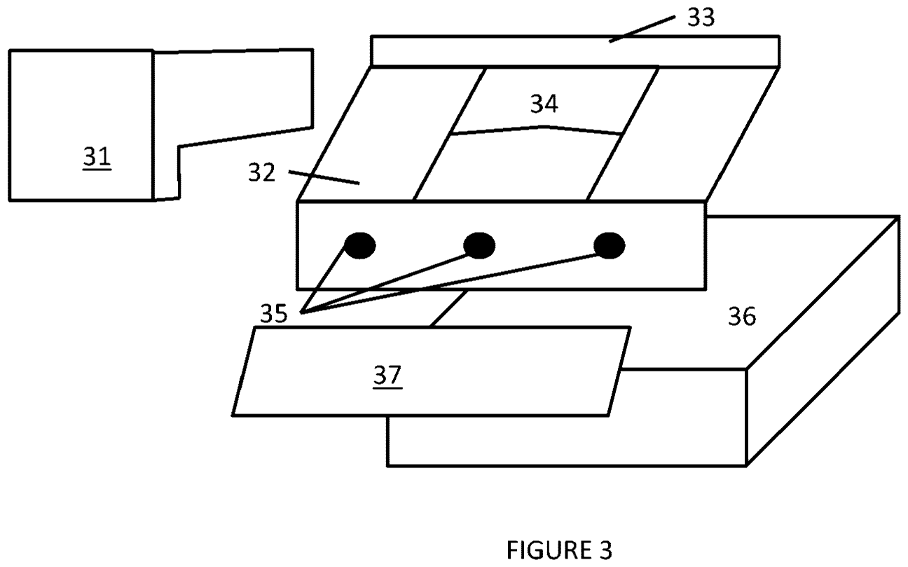

FIG. 3 illustrates an exploded view of a condiment dispenser system. As illustrated in FIG. 3, a condiment dispenser system 30 includes at least one condiment dispenser cabinet or compartment 31. The condiment dispenser cabinet or compartment 31, when the condiment dispenser system 30 is assembled, is placed upon a base plate 32, which includes slide guides 34 and a back plate 33. The slide guides 34 and the back plate 33 assist in positioning the condiment dispenser cabinet or compartment 31 at the proper location on the base plate 32. The base plate 32 also includes motor shafts 35 to engage pump dispensers (not shown) of a condiment dispensing container (not shown). The base plate 32, when the condiment dispenser system 30 is assembled, rests upon a wire frame 36. The condiment dispenser system 30 also includes a condiment tray 37 for holding individual condiment containers (not shown).

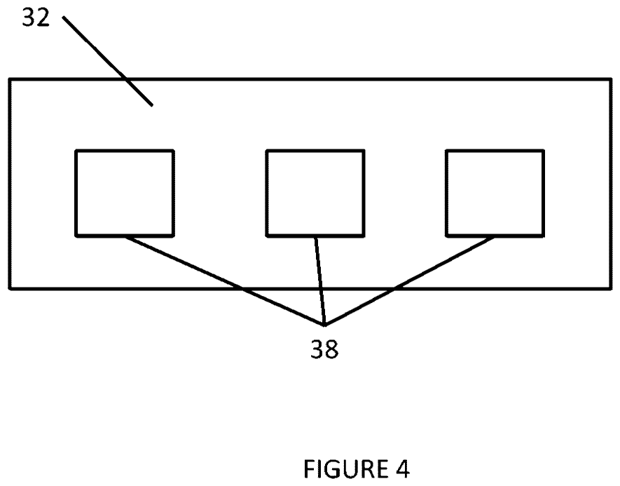

FIG. 4 illustrates another exploded view of the condiment dispenser system of FIG. 3. As illustrated in FIG. 4, a condiment dispenser system 30 includes at least one condiment dispenser cabinet or compartment 31. The condiment dispenser cabinet or compartment 31, when the condiment dispenser system 30 is assembled, is placed upon a base plate 32. The base plate 32 also includes motors 38 to drive the motor shafts (not shown). The motors 38 are activated in response to a human activatable switch (not shown) associated with the condiment dispenser cabinet or compartment 31. The base plate 32, when the condiment dispenser system 30 is assembled, rests upon a wire frame 36.

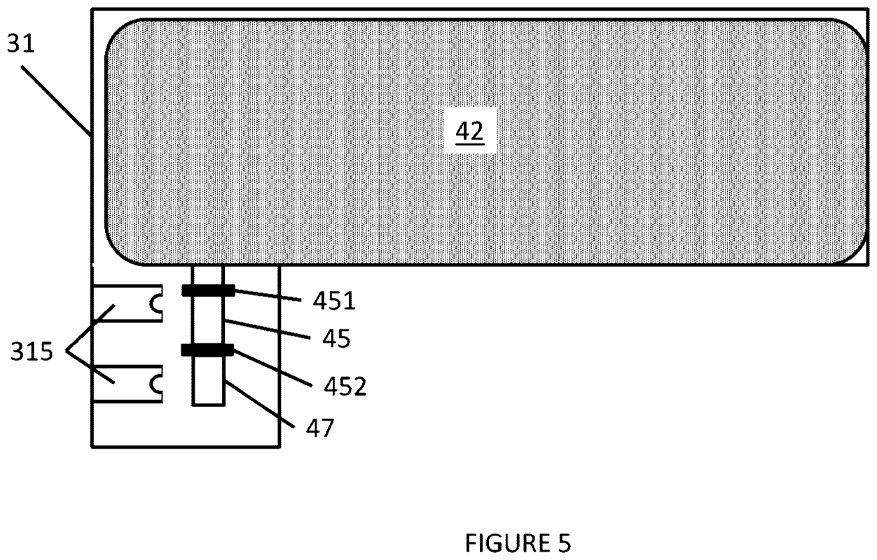

FIG. 5 illustrates a cut-away of a condiment dispenser cabinet or compartment with a full condiment dispensing container. As illustrated in FIG. 5, a condiment dispenser cabinet or compartment 31 has, contained therein, a condiment dispensing container 40 filled with a condiment 42.

The condiment dispensing container 40 may be a vacuum filled bag for holding a condiment 42.

The condiment dispensing container 40 includes, at a dispensing end, a pump 45, which is driven by a motor shaft (not shown) of the condiment dispenser system, to dispense condiment 42 through a condiment dispenser 47.

The pump 45 is held in place by pump holders 315 of the condiment dispenser cabinet or compartment 31. The pump holders 315 of the condiment dispenser cabinet or compartment 31 engage pump holder interfaces 451 and 452 located on the pump 45. The engagement between the pump holder interfaces 451 and 452 and the pump holders 315 enables the pump 45 to be positioned properly to engage the motor shaft (not shown) of the condiment dispenser system.

As illustrated in FIG. 5, the condiment dispenser cabinet or compartment 31 has a door 310 to enable access to the condiment dispensing container 40 for replacement thereof.

It is noted that although condiment dispenser cabinet or compartment 31 is illustrated as having a door 310, the condiment dispenser cabinet or compartment 31 may not have a door wherein the entire condiment dispenser cabinet or compartment 31 is disposed of when replacing the condiment dispensing container 40. In this alternative embodiment, the condiment dispenser system could include removable labels for the condiment dispenser cabinet or compartment 31 to identify the contents of the condiment dispenser cabinet or compartment 31, or the condiment dispenser cabinet or compartment 31 could have a non-removable label thereon.

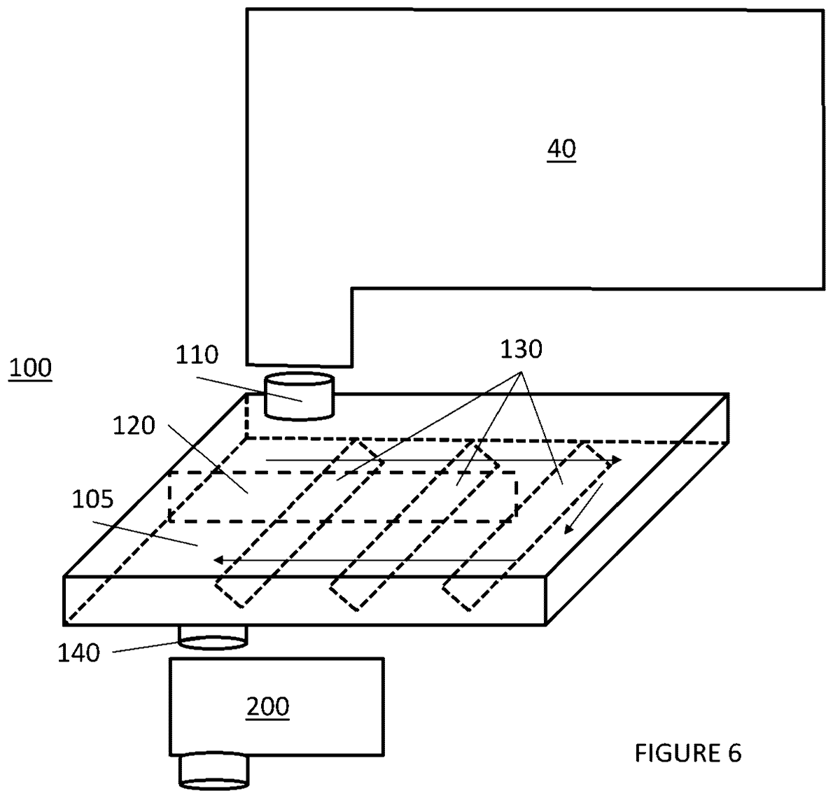

FIG. 6 illustrates a heat transfer unit for heating condiments for use with a condiment dispenser. As illustrated in FIG. 6, a condiment storage unit 40 containing a condiment is connected to a heat exchange unit 100, via a heat exchange unit input opening 110. The heat exchange unit 100, via a heat exchange unit output opening 140, is connected to a pump unit 200 for dispensing the heated condiment.

The heat exchange unit 100 includes a heat exchange unit chamber 105, wherein condiment flows (as illustrated by arrows) from the heat exchange unit input opening 110, around a separation wall 120, to the heat exchange unit output opening 140. The heat exchange unit chamber 105 has included, therein, a plurality of thin film resistive heaters 130.

The plurality of thin film resistive heaters 130 are located on the walls of the heat exchange unit chamber 105 to facilitate the exchange of heat from the plurality of thin film resistive heaters 130 to the condiment as the condiment flows through the heat exchange unit chamber 105.

It is noted that heat exchange unit chamber 105 may be constructed from plastic to facilitate the heat exchange.

It is noted that although the heat exchange unit chamber 105 is illustrated as having a single separation wall 120, the heat exchange unit chamber 105 may contain multiple separation walls to form a serpentine flow path so as to increase the amount time that the condiment interacts with the plurality of thin film resistive heaters 130.

In one embodiment, the heat exchange unit chamber 105 may be constructed as a plastic heat exchanger with the plurality of thin film resistive heaters 130 located on the outside of the heat exchange unit chamber 105 such that the walls of the heat exchange unit chamber 105 function as the heat exchange interface between the plurality of thin film resistive heaters 130 and the condiment within the heat exchange unit chamber 105. In another embodiment, the plurality of thin film resistive heaters 130 are heaters having a maximum operating temperature of 360° F.

The heat transfer unit allows the condiment in the condiment storage unit 40 to be maintained at the proper storage temperature, such as 40° F., while enabling the dispensing of a condiment to a serving temperature, such as 180° F.

The heat transfer unit allows dairy based condiments to be heated without risking scalding or burning of the dairy based condiments.

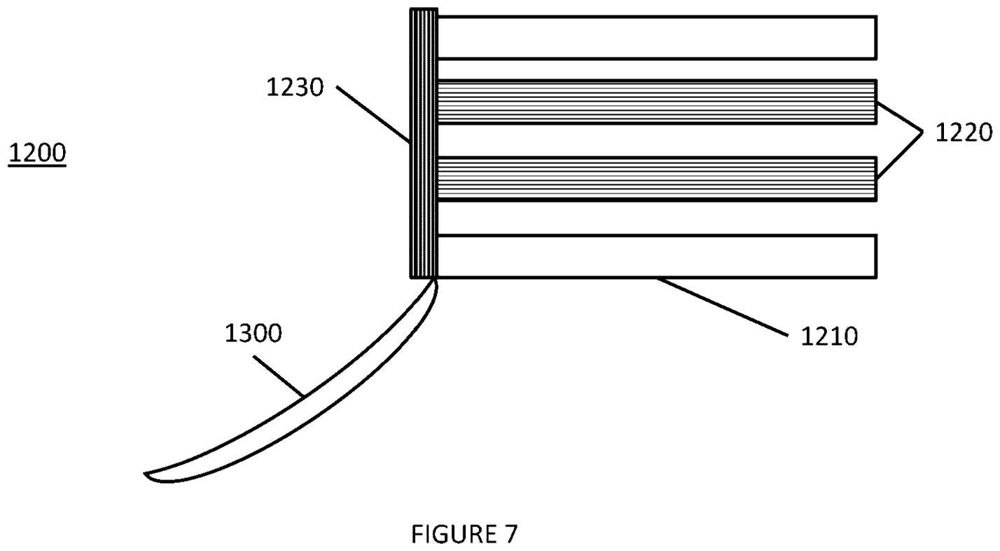

FIG. 7 illustrates a rethermalization unit for a sous vide food product dispenser. As illustrated in FIG. 7, rethermalization unit 1200 includes a wire grill 1220 for holding delaminated sous vide food product (not shown) during a rethermalization and finishing process. The rethermalization and finishing process is realized by heating unit 1210. The heating unit 1210 may be an infrared heat source or a flame source, wherein the flame source provides a grill finish to the delaminated sous vide food product. The rethermalization unit 1200 includes gate 1230 for retaining the delaminated sous vide food product in the rethermalization unit 1200 until the delaminated sous vide food product is ready for dispensing by the dispensing unit 1300.

The finished sous vide food product may be transferred from the rethermalization unit 1200 to the dispensing unit 1300, via gravity, when gate 1230 is opened. Although not illustrated as such, the rethermalization unit 1200 is orientated at an angle such that delaminated sous vide food product in the rethermalization unit 1200 can easily leave the heating unit 1210 via gravity and without human assistance.

Another example of a rethermalization unit for a sous vide food product dispenser is disclosed in co-pending U.S. patent application Ser. No. 18/222,432, filed on Jul. 15, 2023. The entire content of co-pending U.S. patent application Ser. No. 18/222,432, filed on Jul. 15, 2023 is hereby incorporated by reference.

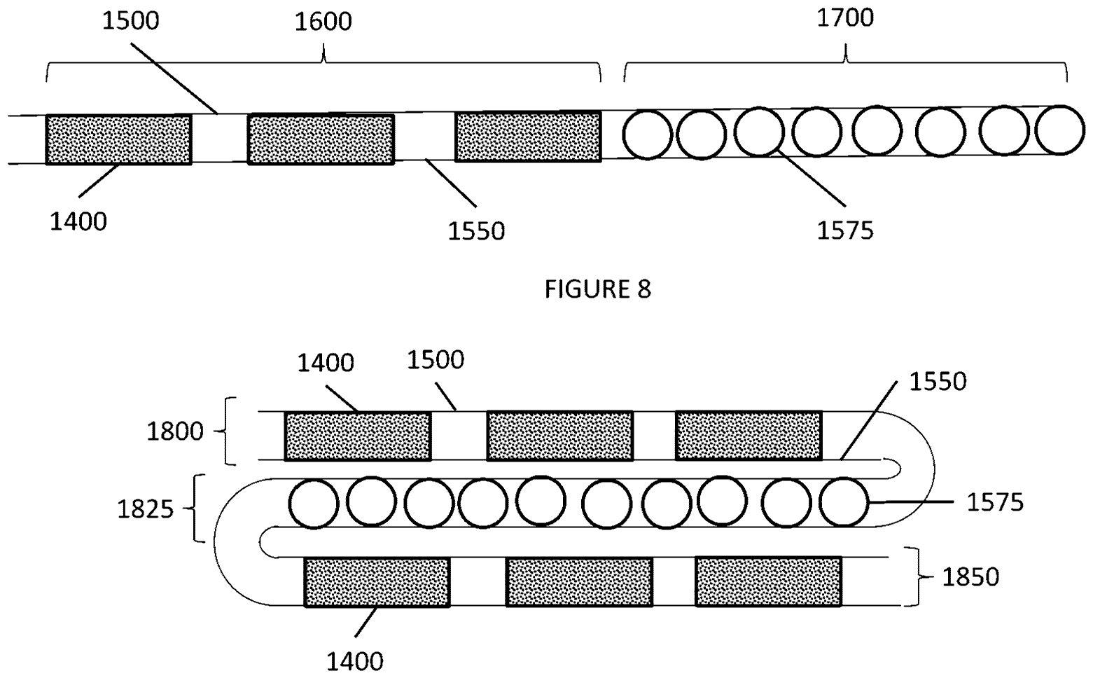

FIG. 8 illustrates the lamination of sous vide food products. As Illustrated in FIG. 8, sous vide food products 1400 are laminated between lamination films 1500 and 1550 to form a sous vide food product area 1600. Following the sous vide food product area 1600, a spacer area 1700 is formed by laminating spacers 1575 between lamination films 1500 and 1550. The length of the sous vide food product area 1600 is substantially equal to the length of the spacer area 1700.

The spacers 1575 may be constructed of volumes of air between the lamination films 1500 and 1550 to form an area resembling bubble wrap.

FIG. 9 illustrates the folding of laminated sous vide food products. As illustrated in FIG. 9, sous vide food products 1400 are laminated between lamination films 1500 and 1550 to form a first sous vide food product layer 1800. Spacers 1575 are laminated between lamination films 1500 and 1550 to form a spacer layer 1825. Sous vide food products 1400 are laminated between lamination films 1500 and 1550 to form a second sous vide food product layer 1850. Spacer layer 1825 is configured to provide an air gap between the first sous vide food product layer 1800 and second sous vide food product layer 1850.

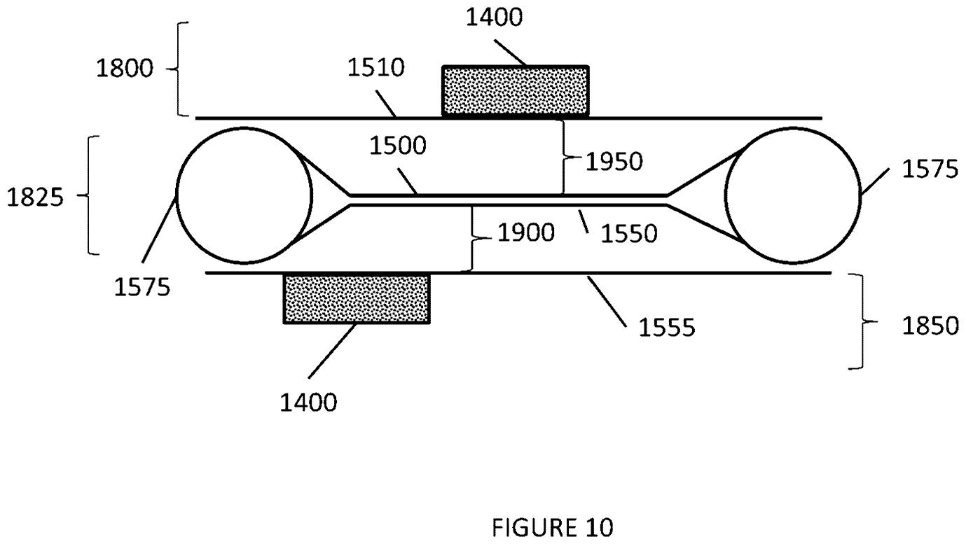

FIG. 10 illustrates air gaps between folds of laminated sous vide food products. As illustrated in FIG. 10, sous vide food products 1400 are laminated onto a lamination film 1510 (which corresponds to lamination film 1500) to form a first sous vide food product layer 1800.

Spacers 1575 are laminated between lamination films 1500 and 1550 to form a spacer layer 1825. Sous vide food products 1400 are laminated onto a lamination film 1555 (which corresponds to lamination film 1550) to form a second sous vide food product layer 1850.

The spacer layer 1825 is configured to provide an air gap 1950 between the lamination film 1510 (which corresponds to lamination film 1500) and the lamination film 1500 and an air gap 1900 between the lamination film 1555 (which corresponds to lamination film 1550) and the lamination film 1550. The air gaps 1900 and 1950 are configured to enable air flow between the first sous vide food product layer 1800 and the second sous vide food product layer 1850.

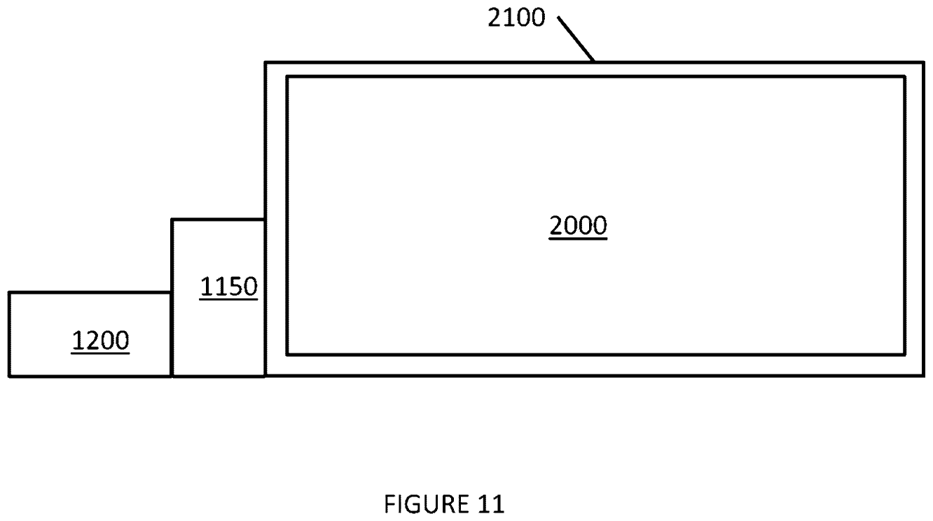

FIG. 11 illustrates a sous vide food product dispenser. As illustrated in FIG. 11, a sous vide food product dispenser includes a sous vide food product storage chamber 2100 that includes therein a sous vide food product storage container 2000. The sous vide food product dispenser includes a rethermalization unit 1200. A delaminator unit 1150 is located between the sous vide food product storage chamber 2100 and the rethermalization unit 1200.

Examples of a delaminator are disclosed in U.S. Pat. Nos. 11,383,506; 11,673,697; and co-pending U.S. patent application Ser. No. 18/230,490. The entire contents of U.S. Pat. Nos. 11,383,506; 11,673,697; and co-pending U.S. patent application Ser. No. 18/230,490 are hereby incorporated by reference.

Another example of a sous vide food product dispenser is disclosed in co-pending U.S. patent application Ser. No. 18/222,432. The entire content of co-pending U.S. patent application Ser. No. 18/222,432 is hereby incorporated by reference.

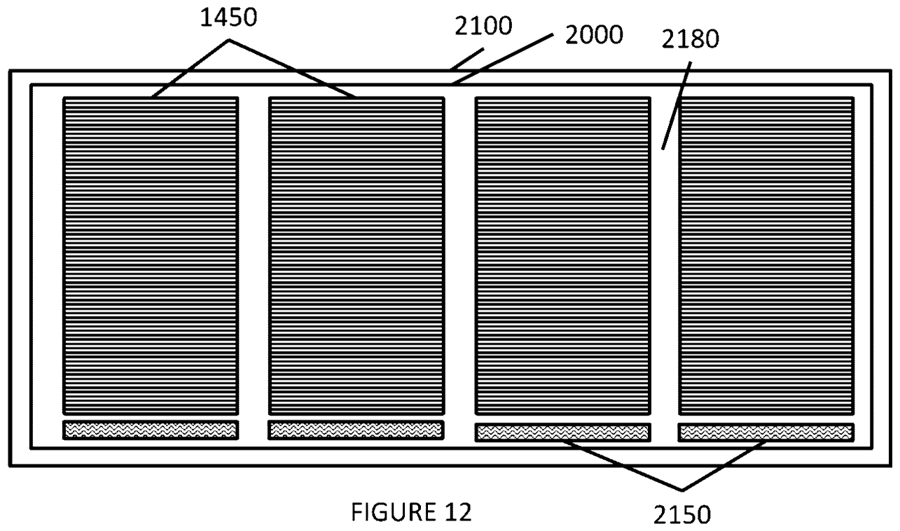

FIG. 12 illustrates a slacking unit for a sous vide food product dispenser. As illustrated in FIG. 12, a sous vide food product storage chamber 2100 includes therein a sous vide food product storage container 2000. The sous vide food product storage chamber 2100 also includes heating areas 2150 for providing the final heating of the sous vide food products 1400 in the sous vide food product storage container 2000. The heating areas 2150 may be thin film resistive heaters.

The sous vide food product storage chamber 2100 includes an air source (not shown) to provide the flow of hot air 2180 between the sous vide food products 1400 in the sous vide food product storage container 2000 for slacking the sous vide food products 1400 in the sous vide food product storage container 2000.

It is noted that the air source (not shown) may also provide the flow of cool or cold air between the sous vide products (not shown) in a sous vide food product storage container (not shown) for the cooling/storing of the sous vide products (not shown) in the sous vide food product storage container (not shown).

In one state of operation, the air source (not shown) may provide hot/warm air to rapidly slack frozen food. The air source (not shown) can also switch to cool/cold air to keep the sous vide products (not shown) in a sous vide food product storage container (not shown) from unnecessarily heating up when heating the bottom food pieces with the heating areas 2150. Thus, the air source (not shown) can use hot/warm or cool/cold air to regulate the temperature of the sous vide products (not shown) in a sous vide food product storage container (not shown), while only applying high temperatures to the heating areas 2150.

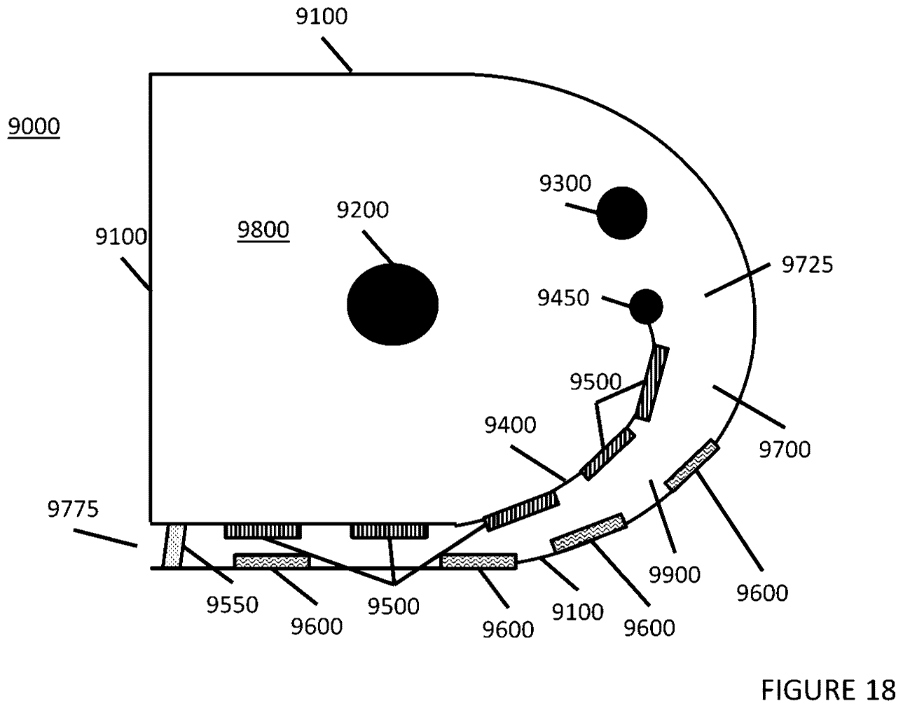

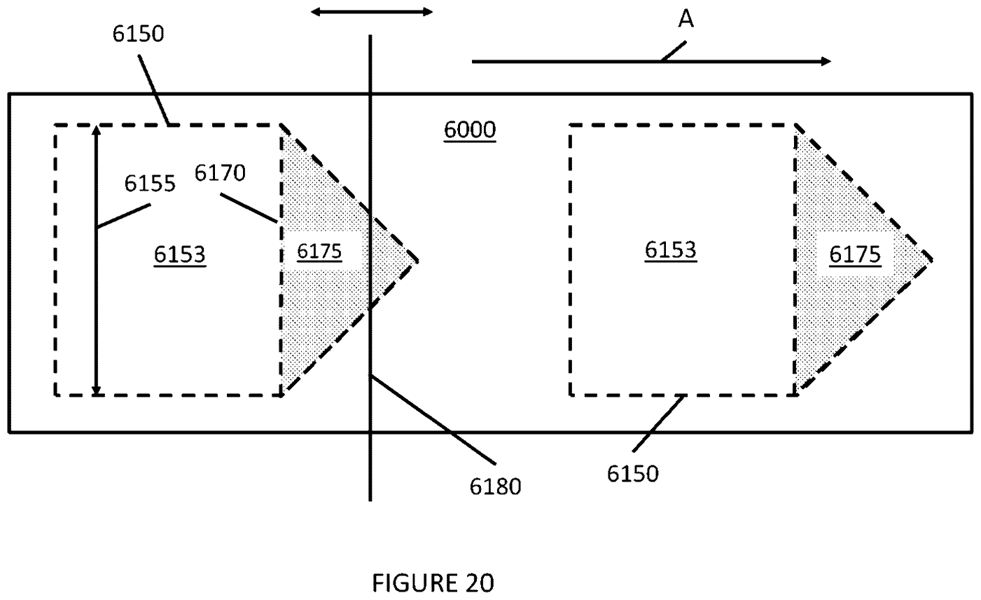

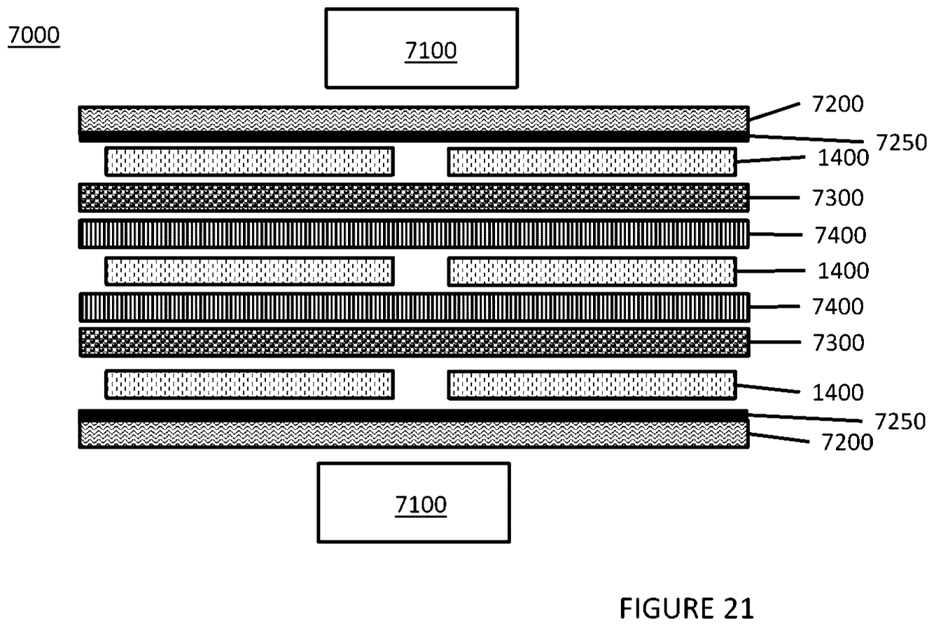

FIG. 12 illustrates a slacking unit for sous vide food product dispensers of FIG. 18 and FIG. 20. As illustrated in FIG. 21, a slacking unit 2100 includes an air source 2175 to provide the flow of hot air between the sous vide products (not shown) in a sous vide food product storage container (not shown) for slacking the sous vide products (not shown) in the sous vide food product storage container (not shown).

It is noted that the air source 2175 may also provide the flow of cool or cold air between the sous vide products (not shown) in a sous vide food product storage container (not shown) for the cooling/storing of the sous vide products (not shown) in the sous vide food product storage container (not shown).

In one state of operation, the air source 2175 may provide hot/warm air to rapidly slack frozen food. The air source 2175 can also switch to cool/cold air to keep the sous vide products (not shown) in a sous vide food product storage container (not shown) from unnecessarily heating up when heating the bottom food pieces with the heating areas 2150. Thus, the air source 2175 can use hot/warm or cool/cold air to regulate the temperature of the sous vide products (not shown) in a sous vide food product storage container (not shown), while only applying high temperatures to the heating areas 2150.

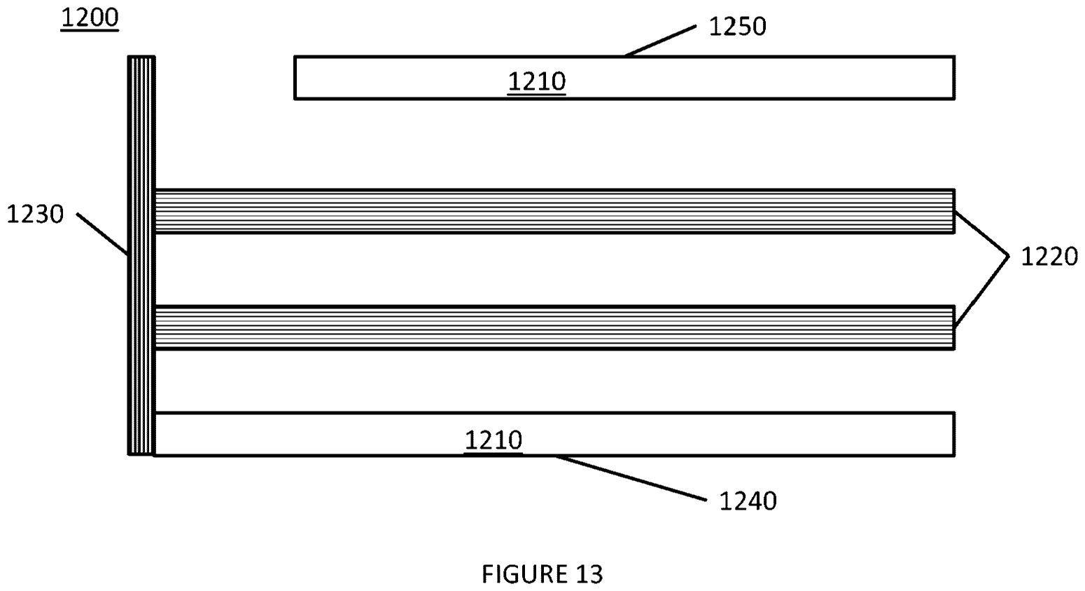

FIG. 13 illustrates a rethermalization unit for a sous vide food product dispenser. As illustrated in FIG. 13, a rethermalization unit 1200 includes a wire grill 1220 for holding delaminated sous vide food product (not shown) during a rethermalization and finishing process. The rethermalization and finishing process is realized by heating unit 1210. The heating unit 1210 may be an infrared heat source 1240 and/or a flame source 1250, wherein the flame source 1250 provides a grill finish to the delaminated sous vide food product.

The rethermalization unit 1200 includes a gate 1230 for retaining the delaminated sous vide food product in the rethermalization unit 1200 until the delaminated sous vide food product is ready for dispensing by the dispensing unit 1300. The finished sous vide food product may be transferred from the rethermalization unit 1200 to the dispensing unit (not shown), via gravity, when gate 1230 is opened.

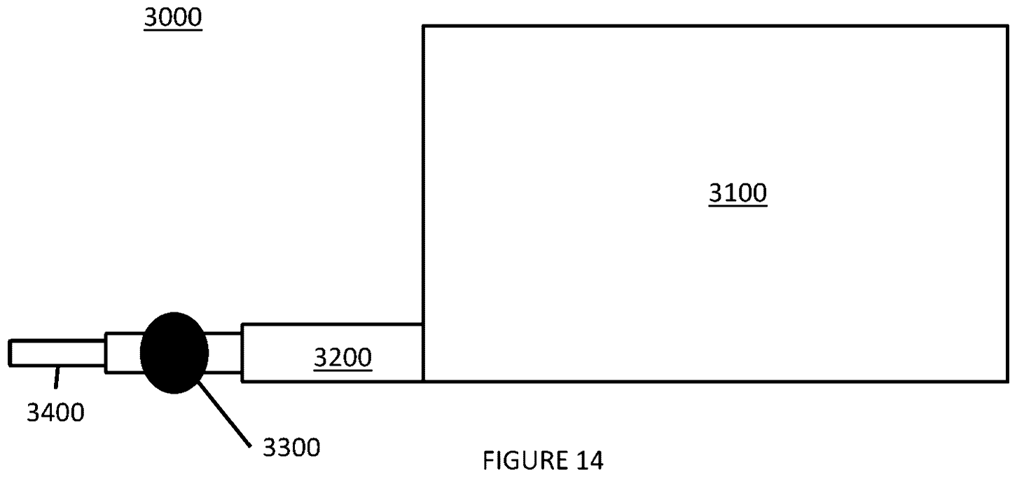

FIG. 14 illustrates a replaceable sous vide food product storage/dispensing container. As illustrated in FIG. 14, a replaceable sous vide food product storage dispensing container 3000 includes a sous vide food product storage container 3100 connected to a heat exchanger 3200. The heat exchanger 3200 is connected to a pump 3300, which is connected to a dispensing member 3400. Contents within the sous vide food product storage container 3100, such as sous vide soup or sauce, departs the sous vide food product storage container 3100 and travels into the heat exchanger 3200.

The heat exchanger 3200 receives heat from a thermal heating unit (not shown) and/or from a microwave unit (not shown) to heat the sous vide soup or sauce. The heated sous vide soup or sauce leaves the heat exchanger 3200 and travels to pump 3300, which pumps the heated sous vide soup or sauce out through the dispensing member 3400.

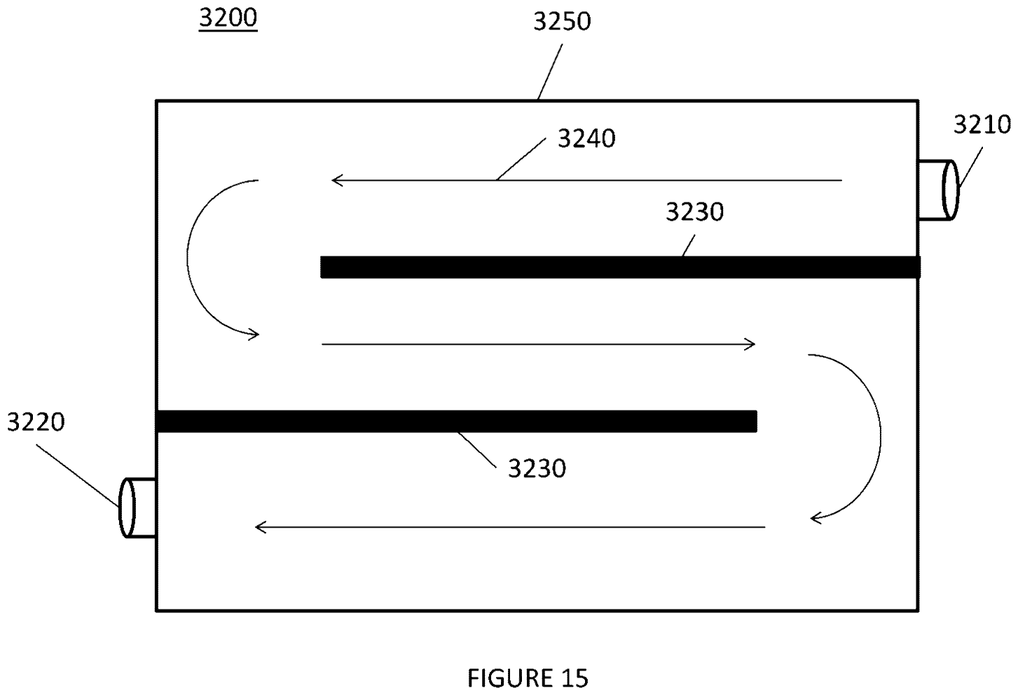

FIG. 15 illustrates a top view of a heat exchanger of a replaceable sous vide food product storage dispensing container. The heat exchanger 3200 includes an inlet or input opening 3210 which is fluidly connected to a sous vide food product storage container (not shown). The heat exchanger 3200 also includes an outlet or output opening 3220 which is fluidly connected to a pump (not shown).

The heat exchanger 3200 includes internal walls 3230 to create a serpentine pathway 3240 for a sous vide soup or sauce (not shown) to travel between the inlet or input opening 3210 and the outlet or output opening 3220, before exiting the heat exchanger 3200. The serpentine pathway 3240 can maximize the time that the sous vide soup or sauce (not shown) is within the heat exchanger 3200, as well as, provide a more even heating of the sous vide soup or sauce (not shown).

The heat exchanger 3200 is constructed of thermally conducive walls 3250, which allow a transfer of heat from a thermal heating unit (not shown) to the heat exchanger 3200 and thus to the sous vide soup or sauce (not shown) contained therein. The thermally conducive walls 3250 may be constructed of plastic.

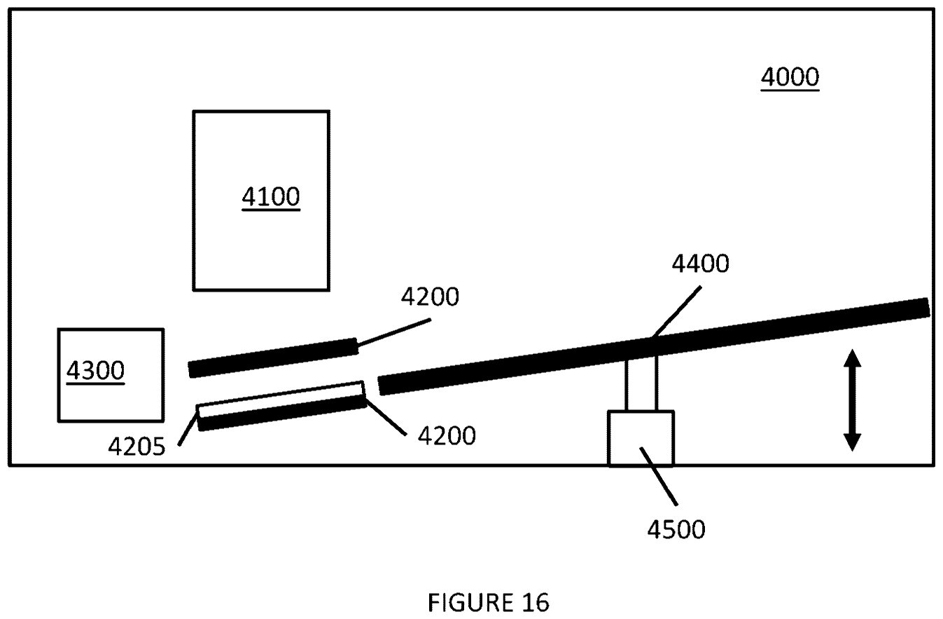

FIG. 16 illustrates a sous vide food product dispensing unit. As illustrated in FIG. 16, a sous vide food product heating/dispensing container 4000 includes a microwave unit 4100, such as a magnetron, to heat the sous vide soup or sauce within the heat exchanger (not shown). The sous vide food product heating/dispensing container 4000 also includes thermal heating unit plates 4200 to provide thermal heat to the walls of a heat exchanger (not shown) to heat the sous vide soup or sauce within the heat exchanger (not shown). The thermal heating unit plates 4200 may be constructed of thin film resistive heaters. The thin film resistive heaters may have a maximum operating temperature of 360° F.

The heat exchanger (not shown) receives heat from thermal heating unit plates 4200 and the microwave unit 4100 to heat the sous vide soup or sauce. The heated sous vide soup or sauce leaves the heat exchanger (not shown) and travels to pump (not shown), which pumps the heated sous vide soup or sauce out through the dispensing member (not shown).

The sous vide food product heating/dispensing container 4000 includes motor 4300 to drive the pump (not shown). The sous vide food product heating/dispensing container 4000 also includes a sous vide food product storage container paddle 4400 upon which a sous vide food product storage container (not shown) rests.

The sous vide food product storage container paddle 4400 provides a rocking motion (as shown by the double-headed arrow), via an actuation mechanism 4500, to the sous vide food product storage container (not shown) to keep the sous vide food product, contained therein, properly mixed (not allowing any contents to settle to the bottom of the sous vide food product storage container (not shown)).

The thermal heating unit plates 4200, the microwave unit 4100, the motor 4300, and the actuation mechanism 4500 are controlled by a controller (not shown).

It is noted that the heat exchanger (not shown) may include thermal sensors (not shown) to monitor the temperature of the sous vide soup or sauce contained therein. The thermal sensors (not shown) are operatively connected to the controller (not shown).

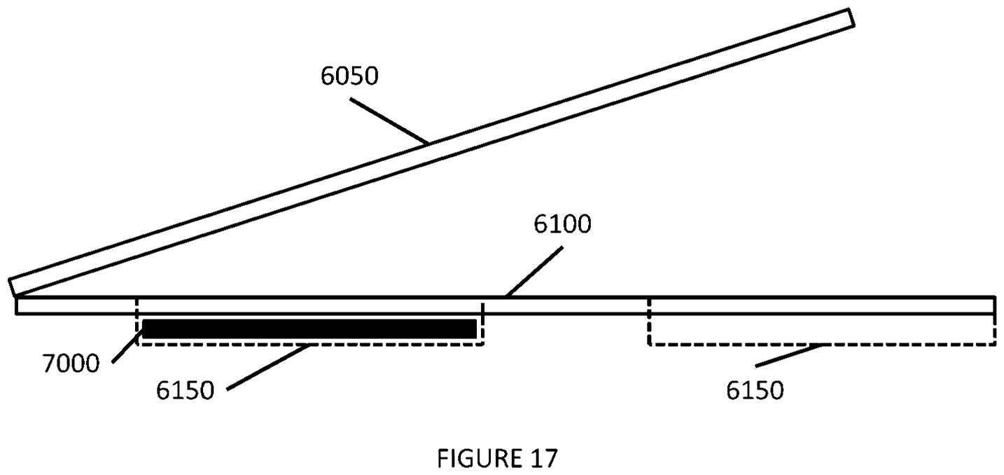

FIG. 17 illustrates an embodiment of lamination of a sous vide food product. As illustrated in FIG. 17, a first laminate film 6050 is laminated to a second laminate film 6100. Between the first laminate film 6050 and the second laminate film 6100, a sous vide food product 7000 is sealed therebetween. The sous vide food product 7000 may be a soup, oatmeal, sauce, or other sous vide food product. The second laminate film 6100, as illustrated, may contain expandable areas 6150, which can expand outwardly to form a volume for containing the sous vide food product 7000. The expandable areas 6150 are located a predetermined distance apart along the second laminate film 6100.

It is noted that the first laminate film 6050 may contain expandable areas (not shown), which can expand outwardly to form a volume for containing the sous vide food product 7000.

It is further noted that both the first laminate film 6050 and the second laminate film 6100 may contain expandable areas (not shown), which can expand outwardly to form a volume for containing the sous vide food product 7000.

FIG. 18 illustrates a cassette for a cartridge of sous vide food products. As illustrated in FIG. 18, a cassette 9000 includes an outer wall 9100. The cassette 9000 further includes a guide wall 9400 which forms a channel 9700 between the outer wall 9100 and the guide wall 9400. The guide wall 9400 also forms a thermal barrier between volume 9800 and volume 9900 so that volume 9800 can be kept at a cold temperature and volume 9900 can be kept at a higher temperature.

Channel 9700 includes an entrance opening 9725 formed by the outer wall 9100 and the guide wall 9400 and an exit opening 9775 formed by the outer wall 9100 and the guide wall 9400. The entrance opening 9725 is configured to receive laminated sous vide food products (not shown). The exit opening 9775 is configured to feed laminated sous vide food products (not shown) into a delamination unit (not shown).

As illustrated, the guide wall 9400 may have a rounded edge 9450 at the entrance opening 9725. Channel 9700 also includes bias members 9500 attached to the guide wall 9400 of channel 9700. The bias members 9500 are configured to bias or urge a laminated sous vide food product (not shown) against the outer wall 9100 of channel 9700. Channel 9700 further includes a bias gate member 9550 attached to the guide wall 9400 of channel 9700. The bias gate member 9550 is configured to bias or urge a laminated sous vide food product (not shown) from not exiting the cassette 9000.

The cassette 9000 includes a peg 9200 located near the center of the volume 9800 and a nip 9300. The peg 9200 is configured to receive a hollow roll (cylinder) (not shown) of a roll of laminated sous vide food products (not shown). The nip 9300 is configured to separate a layer of a roll of laminated sous vide food products (not shown) from the roll of laminated sous vide food products (not shown) to facilitate the feeding of laminated sous vide food products (not shown) into the entrance opening 9725.

Lastly, cassette 9000 includes a heating source 9600, located on/in the outer wall 9100 of channel 9700. The heating source 9600 provides heat to the laminated sous vide food products (not shown), which are located within channel 9700. The heating source 9600 may be constructed of thin film resistive heaters or thin film resistive contact heaters.

It is noted that FIG. 18 shows cassette 9000 configured for a bottom-fed process or configuration. However, the cassette 9000 can be used in a top-fed process or configuration.

In top-fed configuration, the bias members 9500 of the cassette 9000 are attached to the outer wall 9100 of the channel 9700 so that the bias members 9500 bias or urge a laminated sous vide food product (not shown) against the guide wall 9400 of the channel 9700. Moreover, heating source 9600 is located on/in guide wall 9400 of channel 9700. In this configuration, the heating is done above the cool storage volume 9800, thereby providing a more efficient temperature bifurcation or control.

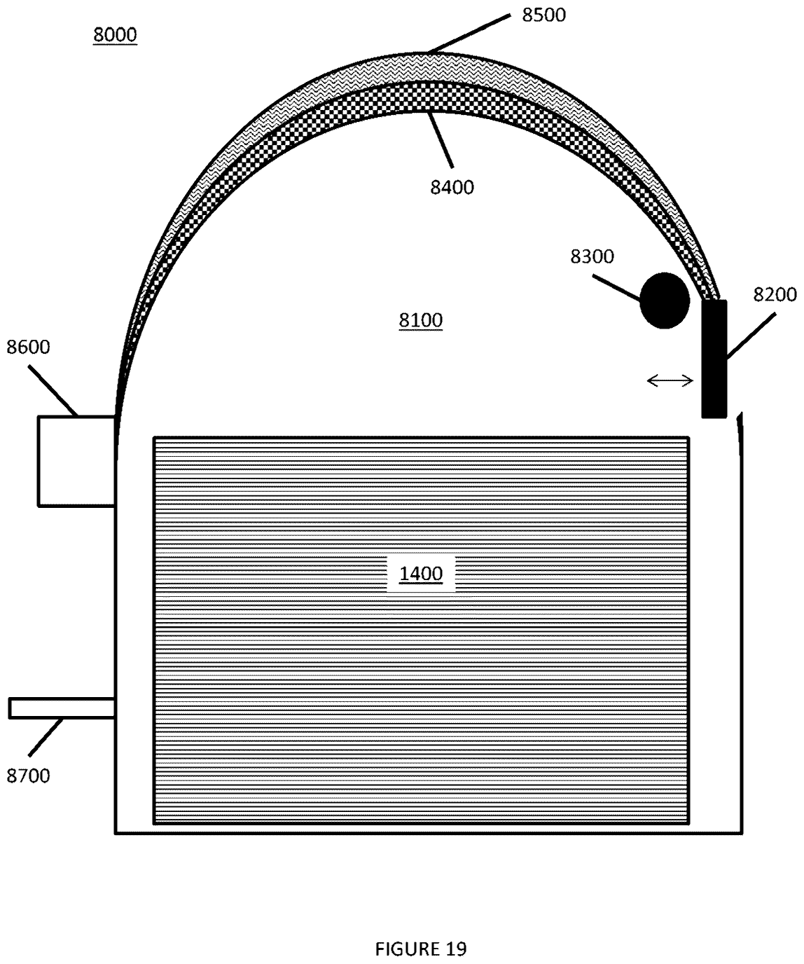

FIG. 19 illustrates a rethermalizing/dispensing unit for sous vide food products. As illustrated in FIG. 19, a fan folded sous vide food product belt 1400 is located in a cold section (cooler) 8100 of a rethermalizing/dispensing unit 8000. The sous vide food product belt 1400 is fed out (not shown) an opening which includes a rubber flap 8200 to provide a temperature barrier between the cold air in the cold section (cooler) 8100 of the rethermalizing/dispensing unit 8000 and a heating unit 8500 located at a top of the rethermalizing/dispensing unit 8000. An insulation layer 8400 is located between the heating unit 8500 and the cold section (cooler) 8100 of the rethermalizing/dispensing unit 8000.

The sous vide food product belt 1400 travels over (not shown) the heating unit 8500 before entering a delaminator 8600. As illustrated, the heating unit 8500 is curved. The heating unit 8500 rethermalizes the sous vide food product in the sous vide food product belt 1400. The rethermalized sous vide food product is separated, by delamination, from the sous vide food product belt 1400 by the delaminator 8600. The delaminated sous vide food product (not shown) is then plated on a plate (not shown) located on a shelf 8700.

The rethermalizing/dispensing unit 8000 further includes a hinge 8300 configured to enable the insulation layer 8400 and heating unit 8500 to open like a clam shell to provide access to the cold section (cooler) 8100 of the rethermalizing/dispensing unit 8000 for filling the cold section (cooler) 8100 of the rethermalizing/dispensing unit 8000 with a new fan folded sous vide food product belt 1400 or removing the fan folded sous vide food product belt 1400.

FIG. 20 illustrates a flow rate control configured packaging for a sous vide food product. As illustrated in FIG. 20, a sous vide food product belt 6000 includes a sous vide food product portion (pocket) 6150 for storing a sous vide food product between two laminated films (not shown). The sous vide food product portion (pocket) 6150 includes a uniform width portion 6153 and a variable width portion 6175.

The uniform width portion 6153 is located at a trailing end of the sous vide food product portion (pocket) 6150 with respect to the travel direction A of the sous vide food product belt 6000 and has a uniform width 6155.

The variable width portion 6175 is located at a leading end of the sous vide food product portion (pocket) 6150 with respect to the travel direction A of the sous vide food product belt 6000, wherein the width of the variable width portion 6175 increases from a leading end to a trialing end of the sous vide food product portion (pocket) 6150.

The sous vide food product portion (pocket) 6150 can be cut along a cut line 6180 to enable the dispensing of the sous vide food product from the sous vide food product portion (pocket) 6150. The location of the cut line 6180 controls or regulates the flow rate (speed) of the dispensing of the sous vide food product from the sous vide food product portion (pocket) 6150.

For example, the closer the cut line 6180 is to the leading end of the variable width portion 6175, the slower the flow rate (speed) of the dispensing of the sous vide food product from the sous vide food product portion (pocket) 6150.

On the other hand, the closer the cut line 6180 is to the trailing end of the variable width portion 6175, the faster the flow rate (speed) of the dispensing of the sous vide food product from the sous vide food product portion (pocket) 6150.

It is noted that the blade used to cut the sous vide food product belt 6000 may be self-cleaning.

FIG. 21 illustrates a rethermalization unit for distinct sous vide food products. As illustrated in FIG. 21, a rethermalization unit 7000 provides a heating area for grilling and air frying of sous vide food. The grilling chamber is constructed of two parallel heated grill plates 7400 that engage the sous vide food 1400 when the sous vide food 1400 enters the grilling chamber.

Each air fryer chamber is constructed of a heater (hot toaster wires) 7200 and a fan 7100 to blow hot air into the air fryer chamber. On the side of each air fryer chamber, opposing the fan 7100, contains air foils 7300 to redirect the hot air back onto the sous vide food 1400 being air fried. Each chambers include a cage (not shown) to hold the sous vide food portion 1400 in place while the sous vide food portion 1400 is brought up the serving temperature. The food cage is constructed of wires or wire mesh.

Each chamber is orientated such that the sous vide food portion 1400 can be gravity fed into the chambers or the sous vide food portion 1400 can be dispensed from the chambers, via gravity.

Another embodiment of a heating area provides grilling and air frying of sous vide food. The grilling chamber is constructed of two parallel heated grill plates that engage the sous vide food when the sous vide food enters the grilling chamber. The air fryer chambers are constructed of a heater (hot toaster wires) and a fan to blow hot air into the air fryer chamber. On the side of the air fryer chambers, opposing the fans, contains air foils to redirect the hot air back onto the sous vide food being air fried. Each chambers include a cage to hold the sous vide food portion in place while the sous vide food portion is brought up the serving temperature.

In an alternative embodiment, the heating unit of the heating area may be constructed of a perforated platen that can distribute air over the surface of the perforated platen. The perforated platen is connected to a hot air blower that creates pressurized hot air in the perforated platen to cause the hot air to exit the perforations in the platen. On the perforated side of the platen, a removable washable wire screen is included to protect the perforated platen from the sous vide food portion. The heating chamber is constructed of two opposing perforated platens.

In another embodiment of a sous vide food dispensing system, the dispensing system includes a heater/dispenser that has movable posts that lowers sous vide food portions, attached thereto, into the heater/dispenser for bringing the sous vide food portion up to serving temperature and dispensing onto or into a serving container, such as a plate or bowl.

Individual sous vide food pouches are attached to the movable posts. Upon reaching serving temperature, the pouch containing the sous vide food portion is cut open so that the sous vide food is dispensed. Below the heater/dispenser is a rotating platform to move the serving container under the appropriate dispensing area to receive the heat sous vide food portion.

After the sous vide food portion is dispensed, the post is raised so that the empty pouch is removed from the heater chamber for proper disposal.

In a further embodiment of a sous vide food portion grill/dispenser, the sous vide food portion grill/dispenser includes a post to lower a sous vide food portion into the grilling chamber and to raise the empty pouch out of the grilling chamber. Upon lowering the pouch containing the sous vide food portion into the grilling chamber, a laser cuts the pouch to release the sous vide food portion into the grilling chamber. The empty pouch is then raised out of the grilling chamber by the movable post for disposal.

At the bottom of the grilling chamber is a wire mesh or steel bars to retain the sous vide food portion in the grilling chamber during the heating process. The wire mesh or steel bars are removed when the sous vide food portion is at serving temperature and is ready to be dispensed.

The wire mesh (screen) or steel bars are moved using a solenoid and can be heated up to 700° F. to sanitize them when they are retracted from the grilling chamber. When retracted, the wire mesh (screen) or steel bars can be scraped to remove any baked-on food.

In an additional embodiment, a sous vide food portion heater/dispenser includes a post to lower a sous vide food portion into the heating chamber and to raise the empty pouch out of the heating chamber. The heating chamber includes two hot air blowers to heat the sous vide food portion up to serving temperature. Upon lowering the pouch containing the sous vide food portion into the heating chamber, a laser cuts the pouch to release the sous vide food portion into the grilling chamber. The empty pouch is then raised out of the heating chamber by the movable post for disposal.

At the bottom of the heating chamber is a wire mesh or steel bars to retain the sous vide food portion in the heating chamber during the heating process. The wire mesh or steel bars are removed when the sous vide food portion is at serving temperature and is ready to be dispensed.

The wire mesh (screen) or steel bars are moved using a solenoid and can be heated up to 700° F. to sanitize them when they are retracted from the grilling chamber. When retracted, the wire mesh (screen) or steel bars can be scraped to remove any baked on food.

In the embodiments discussed above, the pouches of sous vide food portions are of a standard length to facilitate a consistent cutting in the heater/dispenser. If the pouches contain food that requires grilling or frying, the pouch is lowered into the heating chamber and the pouch is cut to dispense the sous vide food into the heating chamber. The pouch is then removed. The sous vide food is heated to serving temperature before dispensing.

If the pouches contain food that does not require grilling or frying (such as soups, steamed vegetables, sauces, or gravy), the pouch is lowered into the heating chamber and the pouch is heated so that the sous vide food portion is brought up to serving temperature. After the sous vide food portion is brought up to serving temperature and ready for dispensing, the pouch is cut to dispense the sous vide food onto or into the serving container.

In another embodiment, a heating element is constructed of two heated plenum (perforated platens) that include protective metal screens and hot air blowers. One heated plenum (perforated platen) is stationary, while the other heated plenum (perforated platen) moves towards the stationary heated plenum (perforated platen) during the heating process. The heating element includes a bottom shelf to hold the sous vide food portion in place during the heating process.

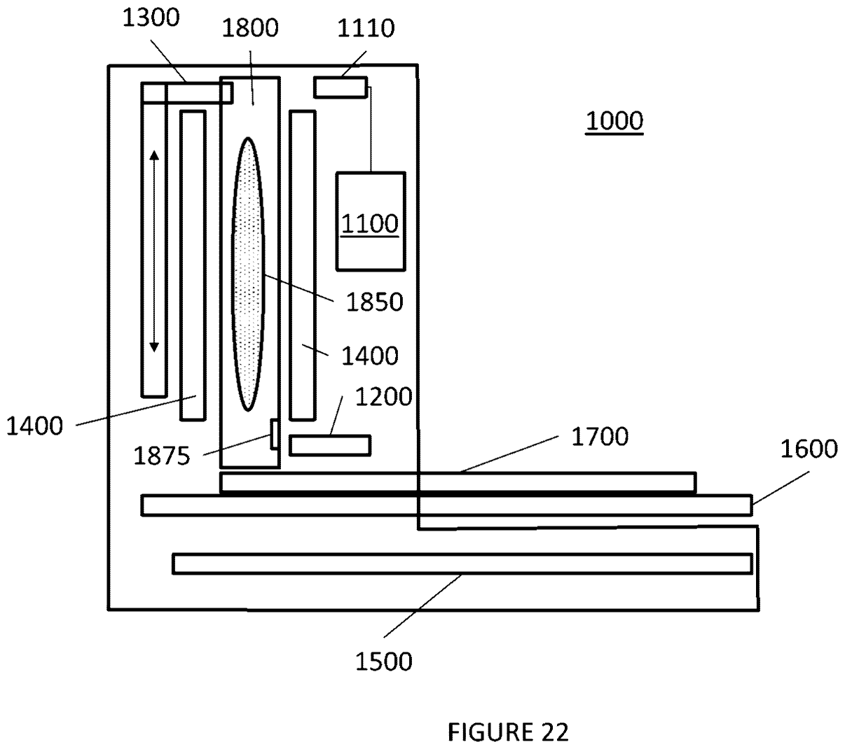

FIG. 22 illustrates a sous vide food dispensing system. The sous vide food dispensing system 1000 includes a housing. Within the housing, a movable post 1300 is configured to move a sous vide food pouch 1800 with a sous vide food portion 1850 therein into a heating chamber and remove the sous vide food pouch 1800 without the sous vide food portion 1850 therein out of the heating chamber. The heating chamber includes opposing heating elements 1400 to heat the sous vide food portion to serving temperature.

The sous vide food dispensing system 1000 includes a controller 1100 which could control the operations of the sous vide food dispensing system 1000. Each pouch 1800 includes a bar code or Q-Code 1875 that includes information about the sous vide food portion 1850 such as the serving temperature, the type of sous vide food portion, the amount of sous vide food, cooking temperature, and cooking time. The bar code or Q-Code 1875 is read by a scanner 1110 which communicates the information to the controller 1100, which uses the information to properly heat the sous vide food portion 1850 to the appropriate serving temperature.

When the sous vide food portion 1850 is at serving temperature and ready to dispense, a rotating platform 1600 rotates a serving container 1700 under a dispensing area for the appropriate dispensing of the sous vide food portion 1850. When the serving container 1700 is in position, a cutting device 1200 (such as a laser cutting device) cuts the pouch 1800 to open it for dispensing of the sous vide food portion 1850.

The sous vide food dispensing system 1000 may include a gate (not shown) to hold the sous vide food portion 1850 within the heating chamber if the movable post removes the pouch 1800 from the heating chamber prior to rethermalization; i.e., when adding a grill mark to the sous vide food portion 1850. The gate opens when the sous vide food portion 1850 is ready to be dispensed.

The sous vide food dispensing system 1000 includes a removable waste tray 1500 for collecting any waste food product from the heating and dispensing process. When the sous vide food portion 1850 has been dispensed, the movable post moves the pouch 1800 out of the heating chamber.

The sous vide food portion 1850 may be dispensed into the heating chamber for grilling or frying, and the pouch 1800 is removed before the grilling or frying process. The sous vide food portion 1850 may be dispensed after the heating process directly onto the serving container 1700, and the pouch 1800 is removed thereafter.

A sous vide food dispensing system for rethermalizing and dispensing a sous vide food portion from a sous vide food pouch includes a housing; a heating chamber configured to heat the sous vide food portion to a serving temperature; a movable post configured to move the sous vide food pouch with the sous vide food portion therein into the heating chamber; and a cutting device configured to cut the sous vide food pouch to facilitate dispensing of the sous vide food portion.

The sous vide food dispensing system may include a scanner for reading machine readable information imprinted on the sous vide food pouch.

The machine readable information may be a barcode or a Q-code.

The machine readable information may include information about cooking time and temperature associated with the sous vide food portion.

The sous vide food dispensing system may include a controller for controlling the heating chamber, the movable post, and the cutting device.

The sous vide food dispensing system may include a controller for controlling the heating chamber based upon the read machine readable information imprinted on the sous vide food pouch.

The sous vide food dispensing system may include a rotating platform configured to move a serving container under the heating chamber to receive the dispensed sous vide food portion.

The sous vide food dispensing system may include a removable waste tray configured to collect any waste food product.

The sous vide food dispensing system may include a retractable member configured to hold the sous vide food portion in the heating chamber during rethermalizing and to release the sous vide food portion in the heating chamber during dispensing.

The sous vide food dispensing system may include a second heating chamber, independently operated from the heating chamber, configured to heat a second sous vide food portion to a second serving temperature when the heating chamber is heating the sous vide food portion to the serving temperature.

A sous vide food dispensing system for rethermalizing and dispensing a sous vide food portion from a sous vide food pouch includes a housing; a heating chamber configured to heat the sous vide food portion to a serving temperature; a movable post configured to move the sous vide food pouch with the sous vide food portion therein into the heating chamber; a cutting device configured to cut the sous vide food pouch to facilitate dispensing of the sous vide food portion; a scanner for reading machine readable information imprinted on the sous vide food pouch; a rotating platform configured to move a serving container under the heating chamber to receive the dispensed sous vide food portion; and a controller operatively connected to the heating chamber, the movable post, the cutting device, the scanner, and the rotating platform; the controller being configured to control the heating chamber based upon the read machine readable information imprinted on the sous vide food pouch; the controller being configured to control the rotating platform to move a serving container under the heating chamber to receive the dispensed sous vide food portion.

The machine readable information may be a barcode or a Q-code.

The machine readable information may include information about cooking time and temperature associated with the sous vide food portion.

A sous vide food dispensing system for rethermalizing and dispensing sous vide food portions from sous vide food pouches includes a housing; a first heating chamber configured to heat a first sous vide food portion to a serving temperature; a second heating chamber configured to heat a second sous vide food portion to a serving temperature; a first movable post configured to move a first sous vide food pouch with the first sous vide food portion therein into the first heating chamber; a second movable post configured to move a second sous vide food pouch with a second sous vide food portion therein into the second heating chamber; a cutting device configured to cut the sous vide food pouches to facilitate dispensing of the sous vide food portions; a scanner for reading machine readable information imprinted on the sous vide food pouches; a rotating platform configured to move a serving container under the heating chambers to receive the dispensed sous vide food portions; and a controller operatively connected to the first heating chamber, the second heating chamber, the first movable post, the second movable post, the cutting device, the scanner, and the rotating platform; the controller being configured to control the first heating chamber based upon the read machine readable information imprinted on the first sous vide food pouch; the controller being configured to control the first heating chamber based upon the read machine readable information imprinted on the second sous vide food pouch; the controller being configured to control the rotating platform to move a serving container under the first heating chamber to receive the dispensed first sous vide food portion; the controller being configured to control the rotating platform to move a serving container under the second heating chamber to receive the dispensed second sous vide food portion.

The machine readable information may be a barcode or a Q-code.

The machine readable information may include information about cooking time and temperature associated with the sous vide food portion.

The sous vide food dispensing system may include retractable members configured to hold the sous vide food portions in the heating chambers during rethermalizing and to release the sous vide food portions in the heating chambers during dispensing.

A method of rethermalizing and dispensing a sous vide food portion from a sous vide food pouch includes (a) automatically lowering, using a movable post, a sous vide food pouch containing a sous vide food portion therein into a heating chamber; (b) reading, using a scanner, machine readable information imprinted on the sous vide food pouch; (c) heating, using the heating chamber, to rethermailzed the sous vide food portion to serving temperature, based upon the read machine readable information imprinted on the sous vide food pouch; (d) automatically removing, using the movable post, the sous vide food pouch without the sous vide food portion therein; and (e) automatically dispensing the rethermailzed sous vide food portion from the heating chamber upon the sous vide food portion reaching the serving temperature.

The method may read, using the scanner, the machine readable information imprinted on the sous vide food pouch before the sous vide food pouch containing the sous vide food portion therein is automatically lowered into the heating chamber.

The method may read, using the scanner, the machine readable information imprinted on the sous vide food pouch while the sous vide food pouch containing the sous vide food portion therein is automatically lowered into the heating chamber.

The machine readable information may be a barcode or a Q-code.

The method may include (f) automatically cutting the sous vide food pouch to facilitate dispensing of the sous vide food portion.

The machine readable information may include information about cooking time and temperature associated with the sous vide food portion.

A method of rethermalizing and dispensing sous vide food portions from sous vide food pouches includes (a) automatically lowering, using movable posts, a first sous vide food pouch containing a first sous vide food portion therein into a first heating chamber and a second sous vide food pouch containing a second sous vide food portion therein into a second heating chamber; (b) reading, using a scanner, machine readable information imprinted on the sous vide food pouches; (c) heating, using the first heating chamber, to rethermailzed the first sous vide food portion to a first serving temperature, based upon the read machine readable information imprinted on the sous vide food pouch associated with the first sous vide food portion; heating, using the second heating chamber, to rethermailzed the second sous vide food portion to a second serving temperature, based upon the read machine readable information imprinted on the sous vide food pouch associated with the second sous vide food portion; automatically removing, using the movable post, the sous vide food pouches without the sous vide food portions therein; automatically dispensing the rethermailzed first sous vide food portion from the first heating chamber upon the first sous vide food portion reaching the first serving temperature; and automatically dispensing the rethermailzed second sous vide food portion from the second heating chamber upon the second sous vide food portion reaching the second serving temperature.

The method may read, using the scanner, the machine readable information imprinted on the sous vide food pouches before the sous vide food pouches containing the sous vide food portions therein are automatically lowered into the heating chambers.

The method may read, using the scanner, the machine readable information imprinted on the sous vide food pouches while the sous vide food pouches containing the sous vide food portions therein are automatically lowered into the heating chambers.

The machine readable information may be a barcode or a Q-code.

The method may include (h) automatically cutting the sous vide food pouches to facilitate dispensing of the sous vide food portions.

The machine readable information may include information about cooking time and temperature associated with the sous vide food portions.

A condiment dispensing container includes a collapsible container; a heat exchanger operatively connected to the collapsible container; a pump operatively connected to the heat exchanger; and a dispensing member operatively connected to the pump.

The heater exchanger may include a plurality of thin film resistive heaters.

The heater exchanger may include a serpentine shaped channel.

A condiment dispensing system includes a housing; a collapsible container; a heat exchanger operatively connected to the collapsible container; a pump operatively connected to the heat exchanger; a motor, located in the housing, operatively connected to the pump; and a dispensing member operatively connected to the pump.

The heater exchanger may include a plurality of thin film resistive heaters.

The housing may include a magnetron configured to heat contents within the heat exchanger.

The heater exchanger may include a serpentine shaped channel.

The housing may include a movable platform configured to agitate contents within the collapsible container.

A sous vide food portion belt includes a first laminate layer; a second laminate layer fused to the first laminate layer; a first set of sous vide food portion expandable areas formed in the second laminate layer; a second set of sous vide food portion expandable areas formed in the second laminate layer; and a spacer region located between the first set of sous vide food portion expandable areas and the second set of sous vide food portion expandable areas; the spacer region including a plurality of volumetric chambers located between the first laminate layer and the second laminate layer.

The volumetric chambers may be volumes of air between the first laminate layer and the second laminate layer.

Each sous vide food portion expandable area may be configured to have a constant width portion located at a trailing end of each sous vide food portion expandable area with respect to a travel direction of the sous vide food portion belt and a variable width portion located at a leading end of each sous vide food portion expandable area with respect to the travel direction of the sous vide food portion belt, a width of the variable width portion increasing from a leading end of the variable width portion to a trailing end of the variable width portion with respect to the travel direction of the sous vide food portion belt.

A sous vide food portion belt includes a first laminate layer; a second laminate layer fused to the first laminate layer; and a sous vide food portion expandable area formed in the second laminate layer; the sous vide food portion expandable area being configured to have a constant width portion located at a trailing end of the sous vide food portion expandable area with respect to a travel direction of the sous vide food portion belt and a variable width portion located at a leading end of the sous vide food portion expandable area with respect to the travel direction of the sous vide food portion belt, a width of the variable width portion increasing from a leading end of the variable width portion to a trailing end of the variable width portion with respect to the travel direction of the sous vide food portion belt.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above.

1. A sous vide food dispensing system for rethermalizing and dispensing a sous vide food portion from a sous vide food pouch, comprising:
a housing;
a heating chamber configured to heat the sous vide food portion to a serving temperature;
a movable post configured to move the sous vide food pouch with the sous vide food portion therein into said heating chamber; and
a cutting device configured to cut the sous vide food pouch to facilitate dispensing of the sous vide food portion.

2. The sous vide food dispensing system as claimed in claim 1, further comprising a scanner for reading machine readable information imprinted on the sous vide food pouch.

3. The sous vide food dispensing system as claimed in claim 2, wherein the machine readable information is a barcode.

4. The sous vide food dispensing system as claimed in claim 2, wherein the machine readable information is a Q-code.

5. The sous vide food dispensing system as claimed in claim 2, wherein the machine readable information includes information about cooking time and temperature associated with the sous vide food portion.

6. The sous vide food dispensing system as claimed in claim 1, further comprising a controller for controlling said heating chamber, said movable post, and said cutting device.

7. The sous vide food dispensing system as claimed in claim 2, further comprising a controller for controlling said heating chamber based upon the read machine readable information imprinted on the sous vide food pouch.

8. The sous vide food dispensing system as claimed in claim 2, further comprising a rotating platform configured to move a serving container under said heating chamber to receive the dispensed sous vide food portion.

9. The sous vide food dispensing system as claimed in claim 2, further comprising a removable waste tray configured to collect any waste food product.

10. The sous vide food dispensing system as claimed in claim 2, further comprising a retractable member configured to hold the sous vide food portion in said heating chamber during rethermalizing and to release the sous vide food portion in said heating chamber during dispensing.

11. The sous vide food dispensing system as claimed in claim 1, further comprising a second heating chamber, independently operated from said heating chamber, configured to heat a second sous vide food portion to a second serving temperature when said heating chamber is heating the sous vide food portion to the serving temperature.

12. A sous vide food dispensing system for rethermalizing and dispensing a sous vide food portion from a sous vide food pouch, comprising:
a housing;
a heating chamber configured to heat the sous vide food portion to a serving temperature;
a movable post configured to move the sous vide food pouch with the sous vide food portion therein into said heating chamber;
a cutting device configured to cut the sous vide food pouch to facilitate dispensing of the sous vide food portion;
a scanner for reading machine readable information imprinted on the sous vide food pouch;
a rotating platform configured to move a serving container under said heating chamber to receive the dispensed sous vide food portion; and
a controller operatively connected to said heating chamber, said movable post, said cutting device, said scanner, and said rotating platform;
said controller being configured to control said heating chamber based upon the read machine readable information imprinted on the sous vide food pouch;
said controller being configured to control said rotating platform to move a serving container under said heating chamber to receive the dispensed sous vide food portion.

13. The sous vide food dispensing system as claimed in claim 12, wherein the machine readable information is a barcode.

14. The sous vide food dispensing system as claimed in claim 12, wherein the machine readable information is a Q-code.

15. The sous vide food dispensing system as claimed in claim 12, wherein the machine readable information includes information about cooking time and temperature associated with the sous vide food portion.

16. A sous vide food dispensing system for rethermalizing and dispensing sous vide food portions from sous vide food pouches, comprising:
a housing;
a first heating chamber configured to heat a first sous vide food portion to a serving temperature;
a second heating chamber configured to heat a second sous vide food portion to a serving temperature;
a first movable post configured to move a first sous vide food pouch with the first sous vide food portion therein into said first heating chamber;
a second movable post configured to move a second sous vide food pouch with a second sous vide food portion therein into said second heating chamber;
a cutting device configured to cut the sous vide food pouches to facilitate dispensing of the sous vide food portions;
a scanner for reading machine readable information imprinted on the sous vide food pouches;
a rotating platform configured to move a serving container under said heating chambers to receive the dispensed sous vide food portions; and
a controller operatively connected to said first heating chamber, said second heating chamber, said first movable post, said second movable post, said cutting device, said scanner, and said rotating platform;
said controller being configured to control said first heating chamber based upon the read machine readable information imprinted on the first sous vide food pouch;
said controller being configured to control said first heating chamber based upon the read machine readable information imprinted on the second sous vide food pouch;
said controller being configured to control said rotating platform to move a serving container under said first heating chamber to receive the dispensed first sous vide food portion;
said controller being configured to control said rotating platform to move a serving container under said second heating chamber to receive the dispensed second sous vide food portion.

17. The sous vide food dispensing system as claimed in claim 16, wherein the machine readable information is a barcode.

18. The sous vide food dispensing system as claimed in claim 16, wherein the machine readable information is a Q-code.

19. The sous vide food dispensing system as claimed in claim 16, wherein the machine readable information includes information about cooking time and temperature associated with the sous vide food portion.

20. The sous vide food dispensing system as claimed in claim 16, further comprising retractable members configured to hold the sous vide food portions in said heating chambers during rethermalizing and to release the sous vide food portions in said heating chambers during dispensing.

21-49. (canceled)
